(19) United States
(12) Patent Application Publication
(10) Pub. No.: US 2010/0107946 A1
(43) Pub. Date: May 6, 2010

(54) Wheel Hub And Bearing Assembly For Use In Agricultural Material Delivery Equipment

(76) Inventors: Kyle David Cooney, Bettendorf, IA (US); Terry L. Snipes, East Moline, IL (US)

Correspondence Address: DEERE & COMPANY, ONE JOHN DEERE PLACE, MOLINE, IL, 61265, US

(21) Appl. No.: 12/262,213

(22) Filed: Oct. 31, 2008

(51) Int. Cl. A01C 5/06; B60B 27/02

(52) U.S. Cl. 111/194; 301/110

(57) ABSTRACT

A wheel and bearing assembly, adapted for use in a packer wheel of an apparatus for delivering agricultural material, such as a planter has a plastic or synthetic hub. To install a bearing in the hub without exceeding the strength of the hub material, the bearing is pressed into a mounting insert made of metal or other high strength material. The insert has a non-circular outer surface and is placed into a complementary shaped cavity in the hub thereby preventing the insert and the bearing outer race from rotating relative to the hub. The fitting between the insert and the hub need only be tight enough to hold the insert in place during handling.

### FIELD OF THE INVENTION

The present invention relates to equipment for delivery of agricultural material, such as a planter, and in particular to a packer wheel and bearing assembly for such equipment.

### BACKGROUND OF THE INVENTION

Packer wheels have long been used with agricultural seeding equipment and fertilizer or other chemical applicators. Such wheels are used to pack the soil above the applied material. As such, the packer wheels operate in a harsh environment and must be durable. Recently developed packer wheels use plastic materials to mold the wheel hub. However, a conventional roller bearing can not be pressed into the plastic hub to produce sufficient holding force to prevent the bearing from slipping relative to the wheel without overstressing the hub material in at least the worst case scenario for the hub and bearing tolerances.

### SUMMARY OF THE INVENTION

A wheel and bearing assembly, adapted for use in a packer wheel of an apparatus for delivering agricultural material, such as a planter, has a plastic or synthetic hub. To install a bearing in the hub without exceeding the strength of the hub material, the bearing is pressed into a mounting insert made of metal or other high strength material. The insert has a non-circular outer surface and is placed into a complementary shaped cavity in the hub thereby preventing the insert and the bearing outer race from rotating relative to the hub. The fitting between the insert and the hub is only tight enough to hold the insert in place during handling. Alternatively, the non-circular external shape could be incorporated into the outer race of bearing. This eliminates the need for the bearing mounting insert to achieve the desired effect of fixing the outer race from rotation relative to the hub.

### BRIEF DESCRIPTION OF THE DRAWINGS

FIG. 1 is a perspective view of the apparatus for delivering agricultural material to the ground including the packer wheel assembly according to the present invention;

FIG. 2 is a sectional view through the packer wheel assembly of the apparatus of FIG. 1; and

FIG. 3 is a partially exploded perspective view of the packer wheel assembly of FIG. 2.

### DESCRIPTION OF THE PREFERRED EMBODIMENT

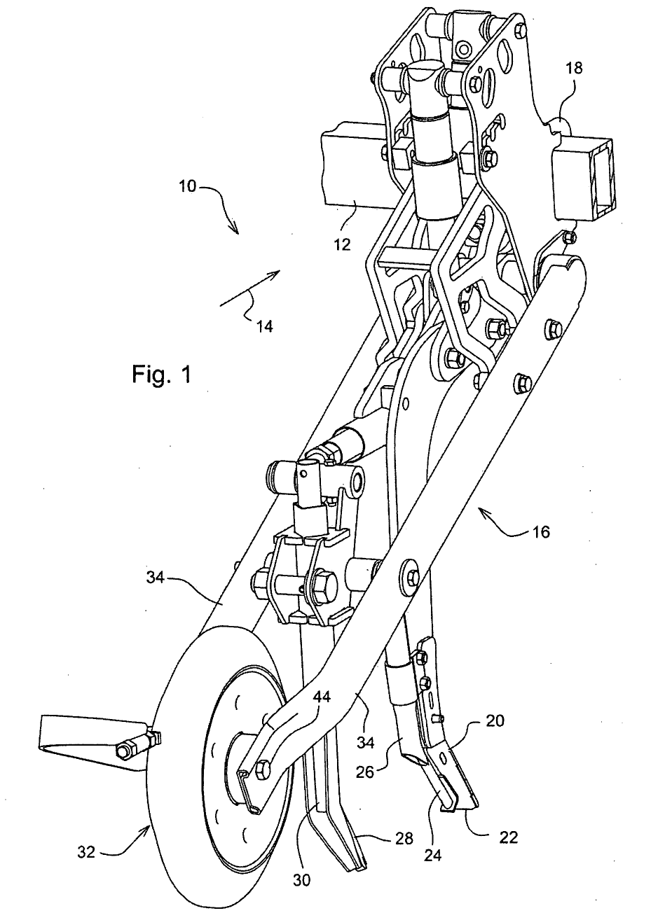

With reference to FIG. 1 an apparatus for delivering agricultural material to the ground having the packer wheel assembly according to the present invention is shown and designated as 10. Apparatus 10 includes a tool bar 12 that extends transversely to a forward travel direction designated by the arrow 14. A material delivery assembly 16 is shown mounted to the tool bar 12 by a U-blots 18 in a known manner. Multiple assemblies 16 are mounted to the tool bar and spaced laterally there along.

The delivery assemblies each include at least one furrow forming shank 20, the lower end 22 of which penetrates the ground to form a furrow as the apparatus 10 is moved in the forward travel direction indicated by the arrow 14. In the embodiment shown, a pair of material delivery conduits 24, 26 are located behind the shank 20. Agricultural materials such as seed, fertilizer or other chemicals can be delivered to the furrow through the material delivery conduits 24, 26. A second furrow forming shank 28 and another material delivery conduit 30 are provided in the assembly 16. A packer wheel assembly 32 is mounted to arms 34 of the assembly 16 and follow behind the two furrow forming shanks 20, 28 to press the soil on the furrows or immediately to the side of the furrows. The material delivery assembly 16 is more fully described in U.S. Pat. No. 6,986,313 which is incorporated herein by reference. The packer wheel assembly of the present invention can be used with other mechanisms for forming a furrow and depositing agricultural material therein and is not limited to use with the assembly 16 shown in FIG. 1.

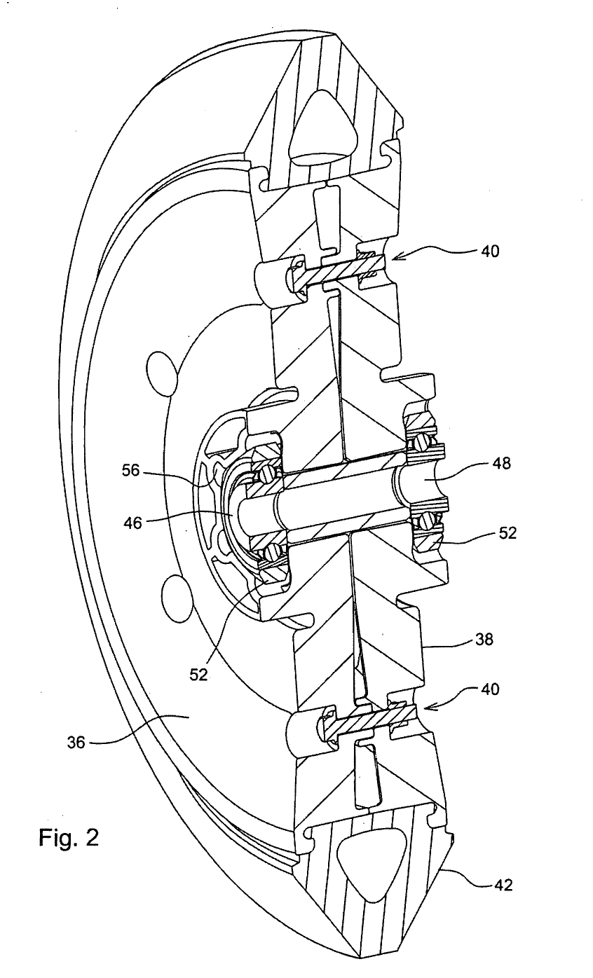

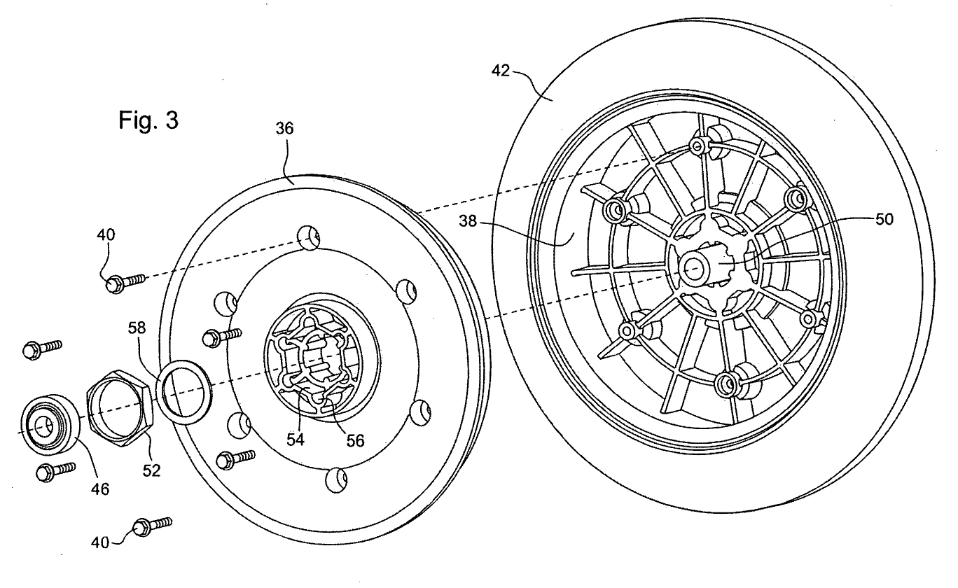

The packer wheel assembly is shown in detail in FIGS. 2 and 3. The packer wheel assembly is constructed of a two-piece hub having left and right members 36, 38. When assembled, the two hub members are joined together by nut and bolt assemblies 40. A natural or synthetic rubber tire 42 surrounds the outer periphery of the hub. The wheel assembly is mounted to the arms 34 through a spindle in the form of a bolt 44 and nut (not shown). The bolt passes through left and right bearings 46, 48 and a sleeve 50 is sandwiched between the bearings. There is a small clearance between the sleeve 50 and the inner bore 52 of the hub members 36, 38 to allow the wheel hub to freely rotate relative to the sleeve.

The bearings 46, 48 are pressed into the inner bore of bearing mounting inserts 52. The outer surface of the inserts is non-circular and fits into complementary shaped cavities 54 in the hub members. In the embodiment shown, the outer surface of the inserts is hexagonal in shape. The cavities 54 are likewise hexagonal, with rounded corners 56 to reduce the stress concentration at the corners. An optional gasket 58 can be used to form a seal between the hub and the bearing outer race and the insert if desired.

The hub members are synthetic, such as 30% glass filled nylon. To press fit the bearing into the nylon would cause the hoop stress in the nylon to exceed the strength of the nylon in the worst case tolerance condition for the hub members and bearings. The mounting inserts, which are made of metal, are pressed onto the bearings and provide the bearing with a non-circular outer surface. When placed in the hub cavities, the non-circular outer surface of the inserts hold the bearings from rotation relative to the hub. While any non-circular outer surface will function for the bearing inserts, the hexagonal shape is preferred due to the readily available material and since the six sides produce less stress at the corners than a four sided polygon. The inserts fit in the hub only tight enough to hold the inserts and bearing in the cavities during handling. The bearing inserts allow a metal bearing to have its outer race fixed to the plastic, or synthetic hub without exceeding he hub material strength. As an alternative to the bearing mounting insert, the non-circular shape can be incorporated into the bearing outer race itself.

While the bearing mounting insert is particularly beneficial in the context of a wheel hub made of plastic, the bearing mounting insert can be used with wheel hubs made of any materials including plastics, ceramics and all metals. This is particularly important where the design of the hub does not permit the hub to be designed to support a press fit of the bearing.

Having described the preferred embodiment, it will become apparent that various modifications can be made without departing from the scope of the invention as defined in the accompanying claims.

1. A wheel hub and bearing assembly comprising:
a bearing having inner and outer races rotatable relative to one another;
a bearing mounting insert having an inner bore onto which the bearing is press fit, the bearing mounting insert having a non-circular outer surface; and
a wheel hub having a cavity for receiving the bearing mounting insert which is shaped complementary to the insert outer surface whereby rotation of the insert relative to the hub is prevented.

2. The wheel hub and bearing assembly as specified in claim 1 wherein the hub is made of a synthetic material.

3. The wheel hub and bearing assembly as specified in claim 1 wherein the hub is made of glass filled nylon.

4. The wheel hub and bearing assembly as specified in claim 2 wherein the bearing mounting insert is made of metal.

5. The wheel hub and bearing assembly as specified in claim 1 wherein the outer surface of the bearing mounting insert is hexagonal.

6. A wheel assembly comprising:
a pair of bearings;
a pair of bearing mounting inserts each having a respective one of the bearings pressed therein, the inserts having a non-circular outer surface;
a wheel hub having opposite sides and a center bore for receiving a mounting spindle, a bearing mounting cavity on each side of the hub, the bearing mounting cavities each having a surface to the outer surface of the inserts into which a respective one of the bearing mounting inserts is disposed whereby the bearings are mounted therein; and
a tire on the outer periphery of the wheel hub.

7. The wheel assembly as specified in claim 6 wherein the hub is made of a synthetic material.

8. The wheel assembly as specified in claim 6 wherein the hub is made of glass filled nylon.

9. The wheel assembly as specified in claim 7 wherein the bearing mounting inserts are made of metal.

10. The wheel assembly as specified in claim 6 wherein the outer surface of the bearing mounting insert is hexagonal.

11. Apparatus for delivering agricultural material to the ground comprising:
a frame supported for movement in a forward direction over the ground;
a plurality of delivery assemblies mounted on the frame at spaced positions across the frame for delivering the agricultural materials to the ground as the frame moves over the ground;
each delivery assembly having means for forming a furrow arranged to penetrate the ground for producing a furrow as the frame is moved across the ground in the forward direction, a material delivery conduit located behind the means for forming a furrow and a packer wheel assembly mounted to engage the ground following the material delivery conduit, the packer wheel assembly comprising:
a pair of bearings;
a pair of bearing mounting inserts each having a respective one of the bearings pressed therein, the inserts having a non-circular outer surface;
a wheel hub having opposite sides and a center bore for receiving a mounting spindle, a bearing mounting cavity on each side of the hub, the bearing mounting cavities each having a surface complementary to the outer surface of the inserts into which a respective one of the bearing mounting inserts is disposed whereby the bearings are mounted therein; and
a tire on the outer periphery of the wheel hub.

12. The apparatus as specified in claim 11 wherein the wheel hub is made of a synthetic material.

13. The apparatus as specified in claim 11 wherein the hub is made of glass filled nylon.

14. The apparatus as specified in claim 11 wherein the bearing mounting inserts are made of metal.

15. The apparatus as specified in claim 11 wherein the outer surface of each of the bearing mounting inserts is hexagonal.

16. A wheel hub and bearing assembly comprising:
a bearing having inner and outer races rotatable relative to one another, the outer race having an outer surface that is non-circular; and
a wheel hub having a cavity for receiving the bearing which is shaped complementary to the outer surface of the outer race into which the bearing is disposed whereby rotation of the insert relative to the hub is prevented.

17. The wheel hub and bearing assembly as specified in claim 16 wherein the hub is made of a synthetic material.

18. The wheel hub and bearing assembly as specified in claim 16 wherein the hub is made of glass filled nylon.

19. The wheel hub and bearing assembly as specified in claim 16 wherein the outer surface of the bearing outer race is hexagonal.
